(19) United States
(12) Patent Application Publication
(10) Pub. No.: US 2026/0185676 A1
(43) Pub. Date: Jul. 2, 2026

(54) TURN LAMP

(71) Applicant: KABUSHIKI KAISHA TOKAI-RIKA-DENKI-SEISAKUSHO, Niwa-gun, Aichi-ken (JP)

(72) Inventors: Kazuya MORI, Aichi (JP); Tomomi HATTORI, Aichi (JP)

(21) Appl. No.: 18/858,143

(22) PCT Filed: Mar. 17, 2023
(86) PCT No.: PCT/JP2023/010700

§ 371 Date: Oct. 18, 2024

(30) Foreign Application Priority Data
Apr. 20, 2022 (JP) 2022-069698

(51) Int. Cl. F21S 43/239; B60Q 1/34; F21S 43/245

(52) U.S. Cl. CPC F21S 43/239; B60Q 1/34; F21S 43/245

(57) ABSTRACT

In a turn lamp, a light guide guides and emits light incident on an inner end surface in a vehicle width direction of a pipe. Here, a flange of the light guide guides the light to the outside in the vehicle width direction of the light guide and the vehicle rear side. Therefore, the amount of light emitted from the outside in the vehicle width direction and the vehicle rear side by the light guide can be increased.

### TECHNICAL FIELD

The present disclosure relates to a turn lamp in which a light guide guides light.

### BACKGROUND ART

In the turn lamp for a door mirror described in Japanese Patent Application Laid-Open (JP-A) No. 2017-185972, a light source emits light to a light incident unit at one end of a light guide member, and the light guide member guides the light to emit the light from a light emission unit on the other end surface. An insertion piece is provided to protrude from the light guide member.

Here, in the turn lamp for a door mirror, the insertion piece of the light guide member is inserted into an inserted portion of a housing, the other end side of the insertion piece is closed by the inserted portion, and the insertion piece does not guide light to the other end side of the light guide member.

### SUMMARY OF INVENTION

### Technical Problem

In consideration of the above fact, an object of the present disclosure is to obtain a turn lamp capable of increasing the amount of light emitted by the light guide from its distal end side.

### Solution to Problem

A turn lamp according to a first aspect of the disclosure includes an emission unit that emits light, a light guide that is provided with a main body unit, guides light emitted from the emission unit to a proximal end side of the main body unit and emits the light from a distal end position to notify a traveling direction of a vehicle, and a protruding portion that protrudes from the main body unit, extends to a distal end side of the light guide, and guides light to the distal end side of the light guide.

In the turn lamp according to a second aspect of the disclosure, in the turn lamp according to the first aspect of the disclosure, the protruding portion guides light to a distal end position of the light guide.

In the turn lamp according to a third aspect of the disclosure, in the turn lamp according to the second aspect of the disclosure, the protruding portion extends to the distal end position of the light guide.

The turn lamp according to a fourth aspect of the disclosure, in the turn lamp according to any one of the first to third aspects of the disclosure, further includes an attachment portion provided on a proximal end side of the light guide, attached to a vehicle side, and integrated with the protruding portion.

The turn lamp according to a fifth aspect of the disclosure, in the turn lamp according to any one of the first to fourth aspects of the disclosure, further includes a transmissive member provided with a transmission portion which is opposite to the distal end position of the light guide and through which light guided to the distal end side of the light guide by the protruding portion is transmitted.

The turn lamp according to a sixth aspect of the disclosure, in the turn lamp according to any one of the first to fifth aspects of the disclosure, includes an uneven portion provided on the main body unit and not provided on the protruding portion.

### Advantageous Effects of Invention

In the turn lamp of the first aspect of the disclosure, the light guide guides the light emitted from the emission unit to the proximal end side of the main body unit of the light guide and emits the light from the distal end position, thereby notifying a traveling direction of the vehicle. The protruding portion protrudes from the main body unit and extends to the distal end side of the light guide.

Here, the protruding portion guides the light to the distal end side of the light guide. Therefore, the amount of light emitted by the light guide from its distal end side can be increased.

In the turn lamp of the second aspect of the disclosure, the protruding portion guides light to the distal end position of the light guide. Therefore, the amount of light emitted by the light guide from its distal end position can be increased.

In the turn lamp of the third aspect of the disclosure, the protruding portion extends to the distal end position of the light guide. Therefore, the amount of light emitted by the light guide from its distal end position can be effectively increased.

In the turn lamp of the fourth aspect of the disclosure, the attachment portion is provided on the proximal end side of the light guide, and the attachment portion is attached to the vehicle side.

Here, the attachment portion is integrated with the protruding portion. Therefore, the light incident on the attachment portion can be guided to the distal end side of the light guide through the protruding portion.

In the turn lamp of the fifth aspect of the disclosure, the transmission portion of the transmissive member faces the distal end position of the light guide, and the transmission portion transmits the light guided to the distal end side of the light guide by the protruding portion. Therefore, the amount of light transmitted through the transmission portion can be increased.

In the turn lamp of the sixth aspect of the disclosure, the uneven portion is provided in the main body unit.

Here, the protruding portion is not provided with an uneven portion. Therefore, the light can be appropriately guided by the protruding portion, and the amount of light guided by the protruding portion to the distal end position of the light guide can be appropriately increased.

### BRIEF DESCRIPTION OF DRAWINGS

FIG. 1A is a view illustrating a door mirror device according to an embodiment of the present disclosure, and is a front view as viewed from the front of a vehicle.

FIG. 1B is a view illustrating the door mirror device according to the embodiment of the disclosure, and is a top view as viewed from above.

FIG. 2A is a view illustrating the turn lamp according to the embodiment of the disclosure, and is a perspective view as viewed from the front side of the vehicle.

FIG. 2B is a view illustrating the turn lamp according to the embodiment of the disclosure, and is a front view as viewed from the front of the vehicle.

FIG. 3 is an exploded perspective view illustrating the turn lamp according to the embodiment of the disclosure as viewed from the front side of the vehicle.

FIG. 4A is a view illustrating a light guide of the turn lamp according to the embodiment of the disclosure, and is a front view as viewed from the front side of the vehicle.

FIG. 4B is a view illustrating the light guide of the turn lamp according to the embodiment of the disclosure, and is a rear view as viewed from the vehicle rear side.

FIG. 4C is a view illustrating the light guide of the turn lamp according to the embodiment of the disclosure, and is a cross-sectional view (a cross-sectional view taken along line 4C-4 C in FIG. 4A) illustrating a pipe of the light guide as viewed from above.

FIG. 4D is a view illustrating the light guide of the turn lamp according to the embodiment of the disclosure, and is a cross-sectional view (a cross-sectional view taken along line 4D-4D in FIG. 4A) illustrating a flange of the light guide as viewed from above.

### DESCRIPTION OF EMBODIMENTS

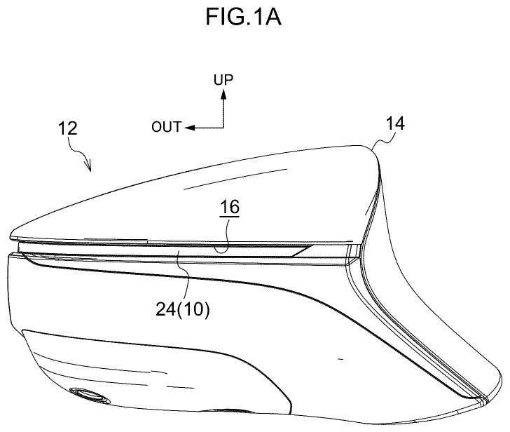

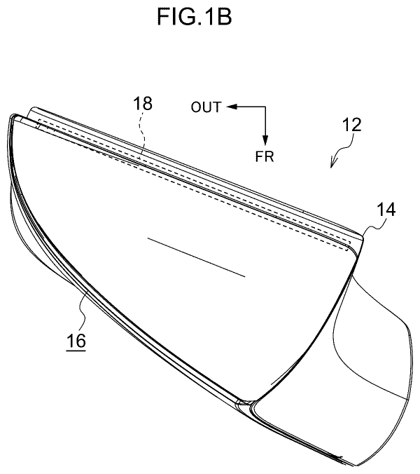

FIG. 1A is a front view of a door mirror device 12 as a visual recognition device according to an embodiment of the present disclosure as viewed from the front of a vehicle, and FIG. 1B is a top view of the door mirror device 12 as viewed from above. In the drawings, the front side of the vehicle is indicated by an arrow FR, the outside in a vehicle width direction (the right side of the vehicle) is indicated by an arrow OUT, and the upper side is indicated by an arrow UP.

The door mirror device 12 according to the present embodiment is installed at a vehicle front end portion of a vertically intermediate portion of a side door (front side door (not illustrated)) in the vehicle (automobile), and is disposed outside the side door.

As illustrated in FIGS. 1A and 1B, the door mirror device 12 is provided with a visor 14 having a substantially rectangular parallelepiped box shape as a covering body, and the visor 14 is supported by a side door. The visor 14 protrudes in a direction toward the rear of the vehicle toward the outside in the vehicle width direction, and the inside of the visor 14 is opened to the rear of the vehicle. The vehicle front wall and the vehicle width direction outer wall of the visor 14 are continuously curved. The vehicle front wall of the visor 14 is inclined in a direction toward the rear of the vehicle as it goes outward in the vehicle width direction. The vehicle width direction outer wall of the visor 14 is disposed substantially perpendicular to the vehicle width direction.

An opening hole 16 having a long and substantially rectangular shape is formed to penetrate from the vehicle front wall to the vehicle width direction outer wall of the visor 14, and the opening hole 16 extends from the inner side of the visor 14 in the vehicle width direction to the outer side thereof in the vehicle width direction. The opening hole 16 opens the inside of the visor 14 to the vehicle front side and the outer side in the vehicle width direction, and an outer end portion of the opening hole 16 in the vehicle width direction is opened to the vehicle rear side.

A rectangular plate-shaped mirror 18 as a visual recognition mechanism is supported by the visor 14, and the front side of the mirror 18 is directed to the vehicle rear side and exposed to the vehicle rear side of the visor 14. Therefore, when an occupant of the vehicle visually recognizes the reflected light of the mirror 18, the occupant's visual recognition of the rear side of the vehicle is assisted.

A turn lamp 10 is provided in the visor 14.

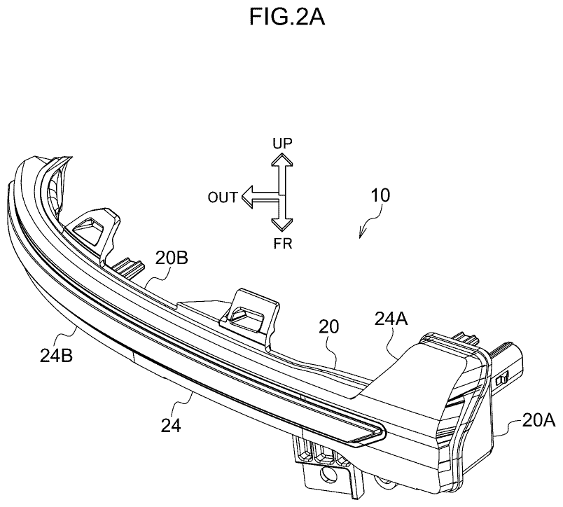

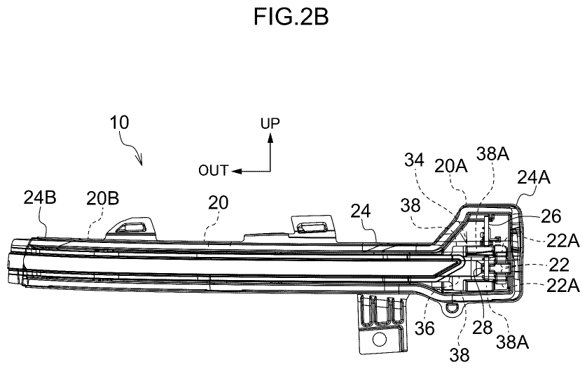

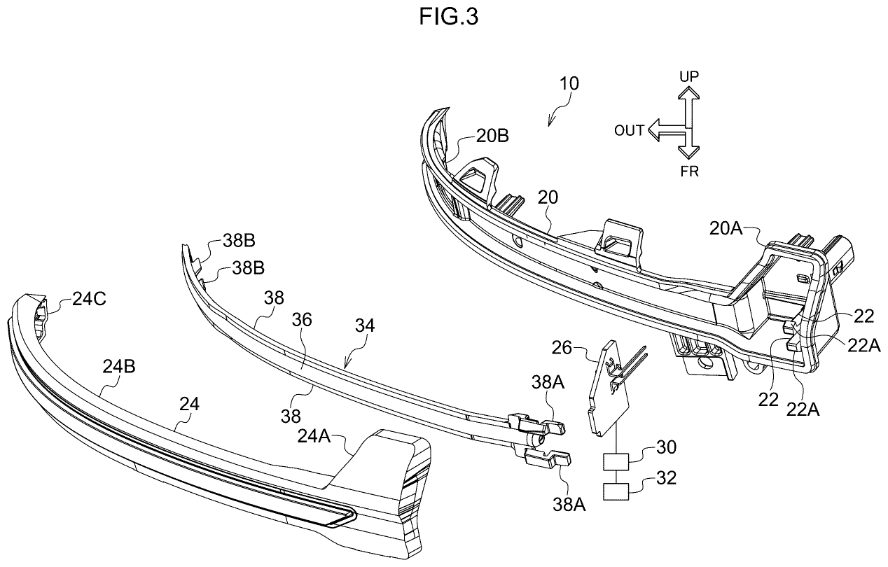

The turn lamp 10 is provided with a housing 20 (see FIGS. 2A, 2B, and 3) having an elongated substantially rectangular parallelepiped box shape as an assembly member, the housing 20 is fixed in the visor 14, and the turn lamp 10 is fixed in the visor 14.

An assembly box 20A having a substantially rectangular parallelepiped box shape is provided in an inner end portion of the housing 20 in the vehicle width direction, and the inside of the assembly box 20A is opened to the front side of the vehicle. A pair of substantially long plate-shaped attachment claws 22 as attachment parts is integrally provided on a vehicle rear wall of the assembly box 20A, and each of the pair of attachment claws 22 extends to the vehicle front side and is arranged in the up-down direction. A substantially triangular prism-shaped claw portion 22A is integrally formed at a distal end portion (vehicle front end portion) of the attachment claw 22, and each of the claw portions 22A of the upper and lower attachment claws 22 protrudes upward and downward, and the vehicle rear side surface is disposed perpendicular to the extending direction of the attachment claw 22.

An arrangement box 20B having an elongated substantially rectangular parallelepiped box shape is integrally provided on the outer side of the assembly box 20A in the vehicle width direction, and the inside of the arrangement box 20B communicates with the inside of the assembly box 20A. The arrangement box 20B is curved in the direction toward the rear side of the vehicle toward the outside in the vehicle width direction, and the inside of the arrangement box 20B is opened to the front side of the vehicle and the outer side in the vehicle width direction and is opened to the rear side of the vehicle at the outer end portion in the vehicle width direction.

A long substantially rectangular parallelepiped box-shaped lens 24 (see FIGS. 2A, 2B, and 3) as a transmissive member is provided on the vehicle front side of the housing 20, and the lens 24 is made transparent to transmit light and is exposed to the outside of the visor 14 from the opening hole 16 of the visor 14.

A cover box 24A having a substantially rectangular parallelepiped box shape is provided at an inner end portion of the lens 24 in the vehicle width direction, and the inside of the cover box 24A is opened to the rear side of the vehicle. The cover box 24A is fitted and fixed to the assembly box 20A of the housing 20, and the cover box 24A covers the vehicle front side of the assembly box 20A.

A transmission box 24B having an elongated substantially rectangular parallelepiped box shape is integrally provided on the outer side of the cover box 24A in the vehicle width direction, and the inside of the transmission box 24B communicates with the inside of the cover box 24A. The transmission box 24B is curved in the direction toward the rear of the vehicle toward the outside in the vehicle width direction, and the inside of the transmission box 24B is opened to the rear of the vehicle and the inside in the vehicle width direction. The transmission box 24B is fitted and fixed to the arrangement box 20B of the housing 20, and the transmission box 24B covers the vehicle front side of the arrangement box 20B and the outer side thereof in the vehicle width direction. The outer end wall of the transmission box 24B in the vehicle width direction is a transmission wall 24C as a transmission portion, and the transmission wall 24C covers the vehicle rear side of the outer end portion of the arrangement box 20B in the vehicle width direction and is exposed to the vehicle rear side from the outer end of the opening hole 16 of the visor 14 in the vehicle width direction.

A substantially rectangular plate-shaped circuit board 26 is assembled in the assembly box 20A of the housing 20, and the circuit board 26 is disposed substantially perpendicular to the vehicle width direction. A substantially rectangular plate-shaped LED28 as an emission unit is fixed to the outside surface of the circuit board 26 in the vehicle width direction, and the LED28 is electrically connected to a vehicle control device 30 via the circuit board 26, thereby emitting light under the control of the control device 30 and emitting light from the outside surface in the vehicle width direction. A turn signal switch 32 as an operation unit of the vehicle is electrically connected to the control device 30, and the turn signal switch 32 is operated by an occupant (particularly, a driver) of the vehicle.

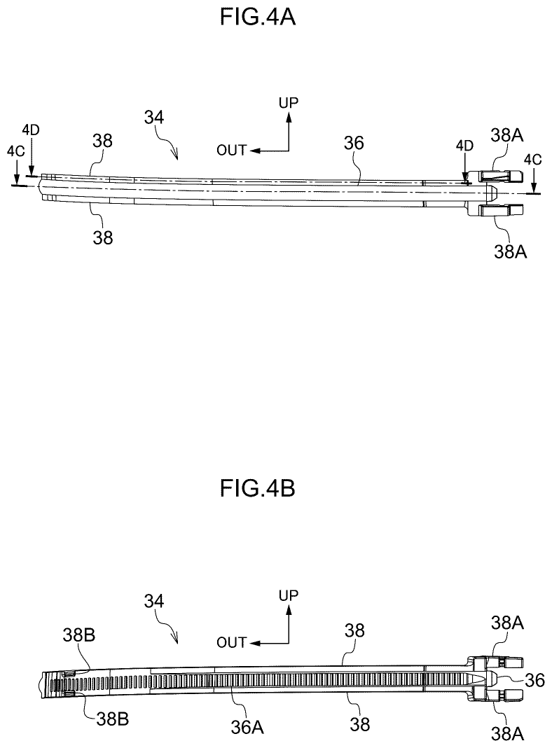

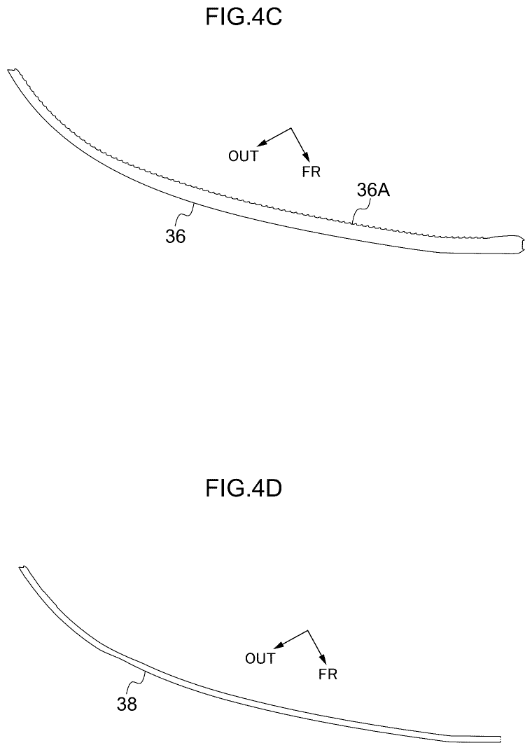

An elongated substantially plate-like light guide 34 (see FIGS. 3 and 4A to 4D) is provided between the housing 20 and the lens 24, and the light guide 34 is made transparent to transmit and guide light.

The light guide 34 is provided with a pipe 36 having a substantially columnar shape as a main body unit, and the pipe 36 is curved in a direction toward the rear of the vehicle toward the outside in the vehicle width direction except for the inner end portion (proximal end portion) in the vehicle width direction. Surfaces on the vehicle rear side of the pipe 36 and in the inner side thereof in the vehicle width direction are curved surfaces directed toward the vehicle rear side toward the outside in the vehicle width direction except for the inner end portion in the vehicle width direction, and a wall thickness dimension (dimensions in the vehicle front-rear direction and the vehicle width direction) of the pipe 36 is reduced toward the outer side in the vehicle width direction and the vehicle rear side except for the inner end portion in the vehicle width direction. An outer end surface (distal end surface) of the pipe 36 in the vehicle width direction is formed in a planar shape, and the outer end surface of the pipe 36 in the vehicle width direction faces the rear side of the vehicle and faces the transmission wall 24C of the lens 24. Serrations 36A as uneven portions are formed on surfaces on the vehicle rear side of the pipe 36 and the inner side thereof in the vehicle width direction except for the inner end portion in the vehicle width direction. In the serrations 36A, recessed portions having a substantially trapezoidal cross section are intermittently formed in a direction toward the outer side in the vehicle width direction and the vehicle rear side. A columnar recessed portion is coaxially formed on the inner end surface of the pipe 36 in the vehicle width direction, and the inner end surface of the pipe 36 in the vehicle width direction faces the outer surface (light emission surface) in the vehicle width direction of the LED28 of the circuit board 26.

On the upper side and the lower side of the pipe 36, a long curved plate-shaped flange 38 as a protruding portion is integrally formed except for the inner end portion in the vehicle width direction, and the flange 38 is curved in a direction toward the rear side of the vehicle as it goes outward in the vehicle width direction. Each of the upper and lower flanges 38 protrudes upward and downward, and a protruding amount of an inner end portion (proximal end portion) of the flange 38 in the vehicle width direction is increased. An outer end surface (distal end surface) of the flange 38 in the vehicle width direction is formed in a planar shape, and the outer end surface of the flange 38 in the vehicle width direction is flush with the outer end surface of the pipe 36 in the vehicle width direction, directed to the rear side of the vehicle, and faces the transmission wall 24C of the lens 24.

A substantially rectangular columnar attachment piece 38A as an attachment portion is integrally formed on the vehicle front side of the inner end portion of the flange 38 in the vehicle width direction, and the attachment piece 38A protrudes inward in the vehicle width direction. The upper and lower attachment pieces 38A are attached to the upper side of the upper attachment claw 22 and the lower side of the lower attachment claw 22 by elastic deformation of the upper and lower attachment claws 22 of the housing 20 (in the assembly box 20A), respectively, and the attachment piece 38A abuts on the vehicle rear side surface of the claw portion 22A of the attachment claw 22.

The attachment piece 38A is in contact with the vehicle front side end surface of the circuit board 26 in the assembly box 20A. Therefore, the inner end portion of the light guide 34 in the vehicle width direction is attached in the assembly box 20A and positioned in the vehicle front-rear direction and the up-down direction.

A substantially rectangular plate-shaped positioning piece 38B is integrally formed on the inner surface in the vehicle width direction of the outer end portion of the flange 38 in the vehicle width direction, and each of upper and lower positioning pieces 38B protrude upward and downward toward the inner side in the vehicle width direction. The distal end of the positioning piece 38B is in contact with the inner surface of the arrangement box 20B of the housing 20, and the outer end portion of the light guide 34 in the vehicle width direction is in contact with the outer wall of the cover box 24A of the lens 24 in the vehicle width direction, whereby the outer end of the light guide 34 in the vehicle width direction is positioned in the vertical direction and the vehicle width direction.

Next, the operation of the present embodiment will be described.

In the door mirror device 12 having the above configuration, in a case where the turn signal switch 32 is operated by the occupant when the traveling direction of the vehicle is changed, the LED28 intermittently emits light to the inner end surface of the pipe 36 of the light guide 34 in the vehicle width direction under the control of the control device 30. Therefore, the light guide 34 (the pipe 36 and the flange 38) guides the light incident on the inner end surface of the pipe 36 in the vehicle width direction and emits the light from the vehicle front surface, the outer surface in the vehicle width direction, and the outer end surface in the vehicle width direction, so that the light is intermittently emitted to the vehicle front side, the outer side in the vehicle width direction, and the vehicle rear side of the visor 14 via the vehicle front wall, the outer wall in the vehicle width direction, and the transmission wall 24C (outer end wall in the vehicle width direction) of the lens 24 and the opening hole 16 of the visor 14, and the traveling direction of the vehicle is notified.

Here, the flange 38 of the light guide 34 guides light to the outside of the light guide 34 in the vehicle width direction and the vehicle rear side (distal end side). Therefore, the amount of light irradiated from the outside in the vehicle width direction and the vehicle rear side by the light guide 34 can be increased.

The flange 38 of the light guide 34 guides the light to the outer end position (distal end position and positions of outer end surfaces of pipe 36 and flange 38 in the vehicle width direction) of the light guide 34 in the vehicle width direction. Therefore, the amount of light emitted from the outer end position in the vehicle width direction by the light guide 34 can be increased.

The flange 38 of the light guide 34 extends to the outer end position of the light guide 34 in the vehicle width direction. Therefore, the flange 38 can effectively guide the light to the outer end position of the light guide 34 in the vehicle width direction, and the amount of light irradiated from the outer end position in the vehicle width direction by the light guide 34 can be effectively increased.

In the light guide 34, the attachment piece 38A is integrated with the flange 38. Therefore, the light emitted from the LED28 and incident on the attachment piece 38A can be guided to the distal end position of the light guide via the flange 38, and the amount of light irradiated from the outer end position in the vehicle width direction by the light guide 34 can be further increased.

The transmission wall 24C of the lens 24 faces the outer end position of the light guide 34 in the vehicle width direction, and the transmission wall 24C transmits light emitted from the outer end position of the light guide 34 in the vehicle width direction. Therefore, the amount of light transmitted through the transmission wall 24C can be increased, and the amount of light emitted to the vehicle rear side of the visor 14 and the outer side thereof in the vehicle width direction can be increased.

The serrations 36A are provided on surfaces of the light guide 34 on the vehicle rear side of the pipe 36 and the inner side thereof in the vehicle width direction. Therefore, the light guided by the pipe 36 can be reflected by the serrations 36A to the vehicle front side and the outside in the vehicle width direction, and the light can be transmitted through the vehicle front wall and the outside wall in the vehicle width direction of the lens 24, so that the amount of light emitted to the vehicle front side and the outside in the vehicle width direction of the visor 14 can be increased.

The serration 36A is not provided in the flange 38 of the light guide 34. Therefore, leakage of the light guided by the flange 38 to the vehicle front side of the flange 38 and the outer side thereof in the vehicle width direction can be suppressed, the flange 38 can appropriately guide the light, and the amount of light guided by the flange 38 to the outer end position of the light guide 34 in the vehicle width direction can be appropriately increased.

In the above embodiment, the flange 38 of the light guide 34 extends to the outer end position of the light guide 34 in the vehicle width direction. However, the flange 38 of the light guide 34 may extend to the vicinity of the outer end position of the light guide 34 in the vehicle width direction, and even in this case, the flange 38 may guide (emit) light to the outer end position (the position of the outer end surfaces of the pipe 36 and the flange 38 in the vehicle width direction in the above embodiment) of the light guide 34 in the vehicle width direction, or the flange 38 may guide (emit) light to the transmission wall 24C of the lens 24.

In the above embodiment, the mirror 18 is provided in the door mirror device 12 (visual recognition device). However, a camera (viewing mechanism) may be provided in the visual recognition device.

In the above embodiment, the visual recognition device is the door mirror device 12 and is provided on the side door of the vehicle. However, the visual recognition device may be formed as a fender mirror device and provided in the fender of the vehicle.

The disclosure of Japanese Patent Application No. 2022-069698 filed on Apr. 20, 2022 is incorporated herein by reference in its entirety.

All documents, patent applications, and technical standards described in this specification are incorporated herein by reference as if each individual document, patent application, and technical standard were specifically and individually described to be incorporated by reference.

1. A turn lamp comprising:
an emission unit, the emission unit being configured to emit light;
a light guide, the light guide being provided with a main body unit, and being configured to guide light emitted from the emission unit to a proximal end side of the main body unit and to emit the light from a distal end position to notify a traveling direction of a vehicle; and
a protruding portion, the protruding portion protruding from the main body unit, the protruding portion extending to a distal end side of the light guide, and being configured to guide light to the distal end side of the light guide.

2. The turn lamp according to claim 1, wherein the protruding portion is configured to guide light to a distal end position of the light guide.

3. The turn lamp according to claim 2, wherein the protruding portion extends to the distal end position of the light guide.

4. The turn lamp according to claim 1, further comprising an attachment portion, the attachment portion being provided on a proximal end side of the light guide, being attached to a vehicle side, and being integrated with the protruding portion.

5. The turn lamp according to claim 1, further comprising a transmissive member, the transmissive member being provided with a transmission portion and being opposite to the distal end position of the light guide, and light guided to the distal end side of the light guide by the protruding portion being transmitted through the transmission portion.

6. The turn lamp according to claim 1, further comprising an uneven portion, the uneven portion being provided in the main body unit and not being provided in the protruding portion.
